(19) United States
(12) Patent Application Publication
(10) Pub. No.: US 2023/0064779 A1
(43) Pub. Date: Mar. 2, 2023

(54) Heat-exchange coffee quick-cooling vessel

(71) Applicant: Weiliang Gu, Shenzhen (CN)

(72) Inventor: Weiliang Gu, Shenzhen (CN)

(21) Appl. No.: 17/411,195

(22) Filed: Aug. 25, 2021

(51) Int. Cl. A47G 19/22

(52) U.S. Cl. CPC A47G 19/2272

(57) ABSTRACT

The invention relates to a heat-exchange coffee quick-cooling vessel, which comprises an outer housing and an inner housing that are connected with each other; the inner space of said inner housing forms the first cavity, the top of said first cavity is open, and a top lid is provided at the opening, while the space between said outer housing and said inner housing forms the second cavity, the bottom of said second cavity is open, and a bottom lid is provided at the opening; the quick-cooling vessel is well-designed and well-constructed, and quickly cools the coffee by the heat exchange of the liquid between the first cavity and the second cavity; compared with the existing quick-cooling method with ice, it preserves the original taste of coffee, featured by environmental protection, energy saving, easy cleaning, beauty and fashion, and it can also be directly used as a drinking cup.

### TECHNICAL FIELD

This utility model relates to a heat-exchange coffee quick-cooling vessel.

### BACKGROUND

In the prior art, the quick cooling method of home brewing coffee is directly adding ice cubes to the coffee. Although this method can cool the coffee quickly, but after the ice melts, it will dilute the coffee and degrade the original flavor and taste of it.

### Contents of the Utility Model

To solve the problem mentioned above, this utility model provides a heat-exchange coffee quick-cooling vessel.

For the above purpose, this utility model provides a heat-exchange coffee quick-cooling vessel, which comprises the outer housing and the inner housing that are connected with each other; the inner space of said inner housing forms the first cavity, the top of said first cavity is open, and a top lid is provided at the opening, while the space between said outer housing and said inner housing forms the second cavity, the bottom of said second cavity is open, and a bottom lid is provided at the opening;

The first cavity is for brew coffee, while the second cavity is for water, and both the coffee and water exchange heat fully by vessel shaking; this quick-cooling vessel is well-designed and well-constructed, which solves the problem of quick-cooling of brewed coffee.

Preferably, said top lid and said inner housing are connected with each other through thread, and the first seal ring is provided at the connection;

In the above technical scheme, the thread connection facilitates the assembly and disassembly of the top lid, and the first seal ring ensures the tightness of the connection.

Preferably, a pour mouth and a flip are arranged on said top lid, and said pour mouth is sealed by closing said flip;

In the above technical scheme, the pour mouth facilitates pouring liquid out from the first cavity.

Preferably, a pore is arranged on said top lid, and a convex part matching with said pore is provided on said flip.

In the above technical scheme, the pore enables air circulation, facilitating pouring liquid out from the first cavity; when the flip is closed, the convex part will seal the pore and ensure tightness.

Preferably, said bottom lid and said outer housing are connected with each other through thread, and the second seal ring is provided at the connection;

In the above technical scheme, the thread connection facilitates the assembly and disassembly of the bottom lid, and the second seal ring ensures the tightness of the connection.

Preferably, said inner housing has an extension part stretching into said first cavity;

In the above technical scheme, the extension part increases the contact area between the first cavity and the second cavity, thus increasing the contact area of heat-exchange.

Compared with the prior art, the invention is advantageous in that this quick-cooling vessel is well-designed and well-constructed, and quickly cools the coffee by the heat exchange of the liquid between the first cavity and the second cavity; compared with the existing quick-cooling method with ice, it preserves the original taste of coffee, featured by environmental protection, energy saving, easy cleaning, beauty and fashion, and it can also be directly used as a drinking cup.

### DRAWINGS

FIG. 1 shows the vertical view of this utility model, i.e., a heat-exchange coffee quick-cooling vessel;

FIG. 2 shows the top view of this utility model, i.e., a heat-exchange coffee quick-cooling vessel;

FIG. 3 is the sectional view of Position A-A in FIG. 2.

FIG. 4 is the schematic diagram of flip closing and opening;

FIG. 5 shows the vertical view of this utility model, i.e., a heat-exchange coffee quick-cooling vessel (another view);

FIG. 6 is the breakdown diagram of this utility model, i.e., a heat-exchange coffee quick-cooling vessel.

Wherein: 1. Outer housing; 2. Second cavity; 3. Inner housing; 31. Extension part; 4. First cavity; 5. First seal ring; 6. Top lid; 61. Pour mouth; 62. Pore; 63. Flip; 631. Convex part; 7. Second seal ring; 8. Bottom lid.

### SPECIFIC EMBODIMENTS

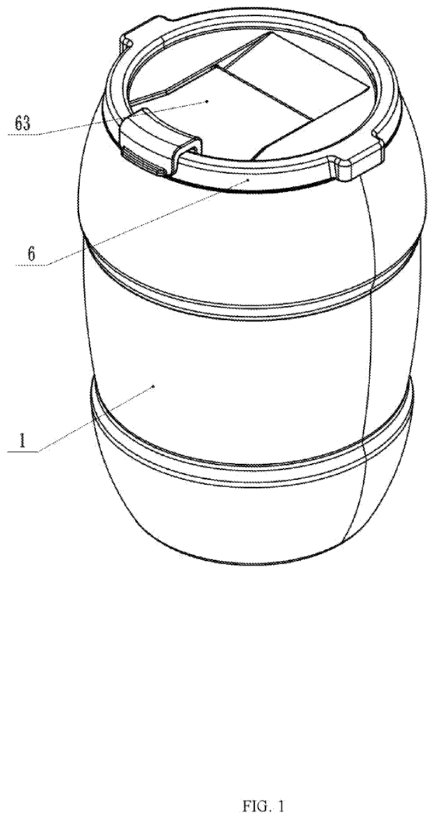

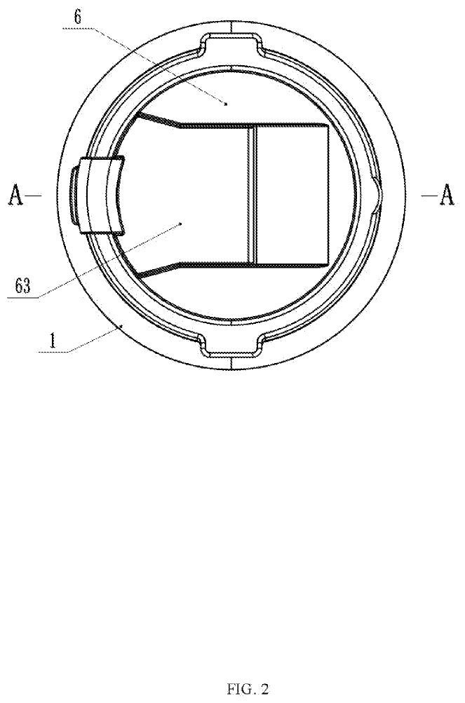

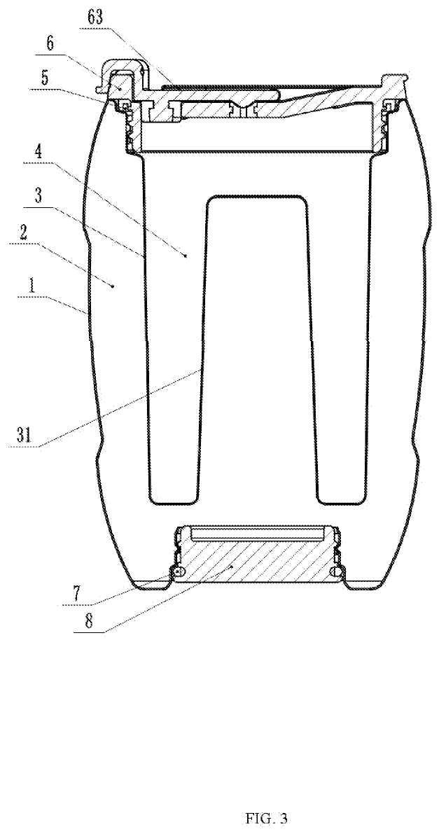

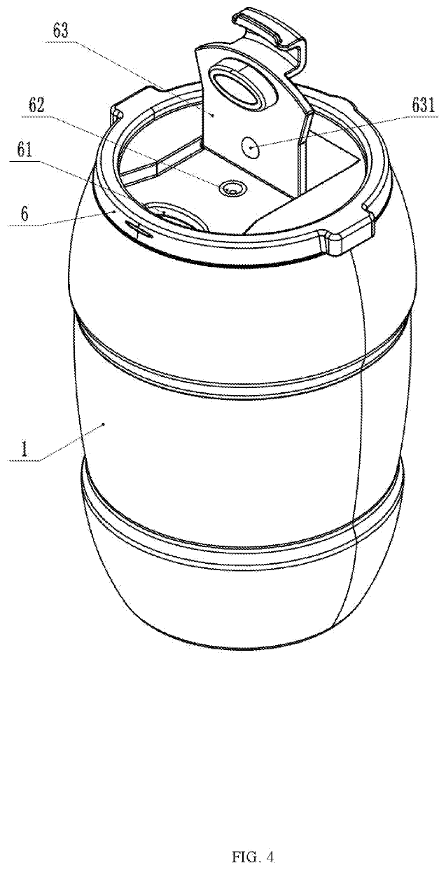

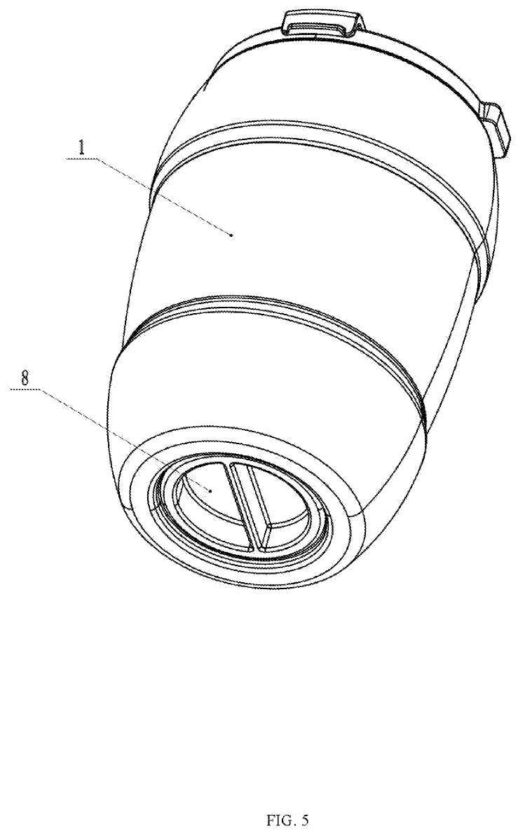

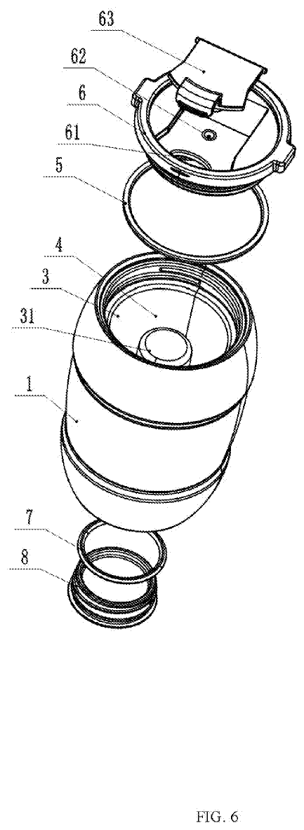

As shown in FIG. 1-6, this utility model provides a heat-exchange coffee quick-cooling vessel, comprising the outer housing 1 and the inner housing 3 that are connected with each other; the inner space of the inner housing 3 forms the first cavity 4, the top of the first cavity 4 is open, and a top lid 6 is provided at the opening, while the space between the outer housing 1 and the inner housing 3 forms the second cavity 2, the bottom of the second cavity 2 is open, and a bottom lid 8 is provided at the opening; wherein, the top lid 6 and the inner housing 3 are connected with each other through thread and the first seal ring 5 is provided at the connection, the thread connection facilitates the assembly and disassembly of the top lid, and the first seal ring ensures the tightness of the connection; a pour mouth 61 and a flip 63 are arranged on the top lid 6, and the pour mouth 61 is sealed by closing the flip 63, the pour mouth facilitates pouring liquid out from the first cavity; a pore 62 is arranged on the top lid 6, and a convex part 631 matching with the pore 62 is provided on the flip 63, the pore enables air circulation, facilitating pouring liquid out from the first cavity, when the flip is closed, the convex part will seal the pore and ensure tightness; the bottom lid 8 and the outer housing 1 are connected with each other through thread, and the second seal ring 7 is provided at the connection, the thread connection facilitates the assembly and disassembly of the bottom lid, and the second seal ring ensures the tightness of the connection; the inner housing 3 has an extension part 31 stretching into the first cavity 4, and the extension part increases the contact area between the first cavity and the second cavity and thus increases the contact area of heat-exchange.

The quick-cooling vessel is well-designed and well-constructed, and cools the coffee by the heat exchange of the liquid between the first cavity and the second cavity; compared with the existing quick-cooling method with ice, it preserves the original taste of coffee, featured by environmental protection, energy saving, easy cleaning, beauty and fashion, and it can also be directly used as a drinking cup.

During practical use, for a better understanding of the utility model, the utility model will be described with reference to the drawings;

Twist off the bottom lid, add a certain amount of pure water into the second cavity, and then twist on the bottom lid and place the quick-cooling vessel into a fridge. When you need to use the vessel, take it out from the fridge, twist off the top lid, add coffee and boiling water, and then twist on the top lid, hold tight and shake the quick-cooling vessel. After about 1 minute of heat exchange, open the flip, and pour coffee out from the first cavity. According to actual tests, the temperature of coffee brewed with 100° C. boiling water can decrease rapidly to 40° C., which is easy and convenient.

Only preferred embodiments of the utility model are described above, which are not to limit the scope thereof. For a person skilled in the art, the utility model may take on various alterations and changes. Any alteration, equivalent replacement and improvement, etc. without departing from its spirit and principle of the utility model shall be included in the scope of protection of the utility model.

1. A heat-exchange coffee quick-cooling vessel, wherein, it comprises the outer housing (1) and the inner housing (3) that are connected with each other; the inner space of said inner housing (3) forms the first cavity (4), the top of said first cavity (4) is open, and a top lid (6) is provided at the opening, while the space between said outer housing (1) and said inner housing (3) forms the second cavity (2), the bottom of said second cavity (2) is open, and a bottom lid (8) is provided at the opening.

2. A heat-exchange coffee quick-cooling vessel according to claim 1, wherein said top lid (6) and said inner housing (3) are connected with each other through thread, and the first seal ring (5) is provided at the connection.

3. A heat-exchange coffee quick-cooling vessel according to claim 1, wherein a pour mouth (61) and a flip (63) are arranged on said top lid (6), and said pour mouth (61) is sealed by closing said flip (63).

4. A heat-exchange coffee quick-cooling vessel according to claim 3, wherein a pore (62) is arranged on said top lid (6), and a convex part (631) matching with said pore (62) is provided on said flip (63).

5. A heat-exchange coffee quick-cooling vessel according to claim 1, wherein said bottom lid (8) and said outer housing (1) are connected with each other, and the second seal ring (7) is provided at the connection.

6. A heat-exchange coffee quick-cooling vessel according to claim 1, wherein said inner housing (3) has an extension part (31) stretching into said first cavity (4).
